(19) United States
(12) Patent Application Publication
(10) Pub. No.: US 2010/0008618 A1
(43) Pub. Date: Jan. 14, 2010

(54) Modulated optical waveguide sensor

(76) Inventor: Basil I. Swanson, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/345,105

(22) Filed: Jan. 31, 2006

Related U.S. Application Data
(60) Provisional application No. 60/649,753, filed on Feb. 1, 2005.

(51) Int. Cl. G02B 6/00; G01N 21/00

(52) U.S. Cl. 385/12; 436/164

(57) ABSTRACT

The present invention provides both materials and processes that use an optical transduction technique employing modulation of a biological recognition event at the surface of a waveguide. This approach relies on fluorescence of a reporter material, such as a dye, that is attached to a recognition molecule whose position relative to the surface of a waveguide, e.g., a planar optical waveguide, is modulated by electric, magnetic or acoustic fields or a combination of such fields.

### RELATED APPLICATIONS

This application claims the benefit of U.S. Provisional Patent Application Ser. No. 60/649,753 filed Feb. 1, 2005.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates to an optical waveguide based sensor employing modulation of a biological recognition event at the optical waveguide surface and to a process of detecting either a single targeted species or a multiplicity of targeted species simultaneously by using such a modulated sensor.

### BACKGROUND OF THE INVENTION

There is an increasing demand for development of generic biosensor technologies that are both highly sensitive and specific, and which afford detection of a wide range of biological agents. It is clearly advantageous from a deployment standpoint if the biosensor systems remain fairly simple to use and can be constructed in a compact format. Biological sensors are routinely based on the immobilization of a recognition molecule at the surface of a transducer (a device that can transform a binding event between the target molecule and the recognition element into a measurable signal). Specificity in binding to a target is important as many sensor systems have high levels of non-specific binding that makes detection of a specific recognition event more difficult. Various types of optical sensors using planar optical waveguides have been known. For example, Tiefenthaler et al. (J. Opt. Soc. Am. B, 6 (1989) 209) and Lukosz et al. (Sensors Actuators, 15 (1988) 273) reported on the use of optical grating couplers as biochemical sensors. Optical biosensors have also been described in U.S. Pat. No. 5,194,393 by Hugl et al. and U.S. Pat. No. 5,711,915 by Siegmund et al. In the later patent, fluorescent dyes were used in the detection of molecules. Additionally, U.S. Pat. No. 6,297,058, by Song et al. for “Triggered Optical Biosensor”, describes optical biosensors using measurement of changes in fluorescent properties from a signal transduction and amplification directly coupled to the recognition event wherein fluorophore labeled recognition molecules form aggregates upon binding to multivalent biological species. Flow cytometry techniques have been employed as well.

Despite the recent progress in such signal transduction and amplification directly coupled to a recognition event, further improvements have been desired especially in the development of optical biosensors, especially compact, field-capable optical biosensors. Further, the need exists for sensors or environmental sensing systems that can be remotely situated and left largely unattended. Such sensors or systems would require both robust surfaces and robust ligands.

### SUMMARY OF THE INVENTION

In accordance with the purposes of the present invention, as embodied and broadly described herein, the present invention includes an optical waveguide sensor for the detection of a binding event to a target molecule including an optical waveguide, a fluid membrane or self assembled surface thereon said optical waveguide, recognition molecules situated near said fluid membrane or self assembled surface by: (a) in the case of a fluid membrane, a trifunctional linker molecule including a recognition molecule, a fluorescent reporter molecule, anchoring groups for situating within said fluid membrane and a spacer group of a predetermined length between the anchoring groups and the portion of the trifunctional linker structure containing the recognition molecule and the fluorescent reporter molecule or (b) in the case of a self assembled surface, a trifunctional linker molecule including a recognition molecule, a fluorescent reporter molecule, and a spacer of a predetermined length capable of binding at said self assembled surface, where said spacer is positioned between the self assembled surface and the portion of the trifunctional linker structure containing the recognition molecule and the fluorescent reporter molecule, such predetermined length sufficient so as to allow detectable modulated movement under the application of an external field, said recognition molecules capable of binding with said target molecule, an optical energy source for generating both an evanescent field at the surface of said optical waveguide and exciting the fluorescent reporter molecule so as to generate detectable fluorescence signals, a modulation source selected from the group consisting of electrical fields, magnetic fields and acoustic fields, said modulation source capable of causing changes in positional location of said recognition molecules relative to said optical waveguide, and, a detector positioned so as to allow for sensing of the fluorescence signals from the waveguide.

The present invention also includes a process of detecting a targeted species including contacting a sample with an optical waveguide sensor having a fluid membrane or self assembled surface thereon said optical waveguide, a chemical moiety including recognition molecules situated near the fluid membrane or self assembled surface by: (a) in the case of a fluid membrane, a trifunctional linker molecule including a recognition molecule, a fluorescent reporter molecule, anchoring groups for situating within the fluid membrane and a spacer of a predetermined length between the anchoring groups and the portion of the trifunctional linker structure containing the recognition molecule and the fluorescent reporter molecule or (b) in the case of a self assembled surface, a trifunctional linker molecule including a recognition molecule, a fluorescent reporter molecule, and a spacer of a predetermined length capable of binding at the self assembled surface, where the spacer is positioned between the self assembled surface and the portion of the trifunctional linker structure containing the recognition molecule and the fluorescent reporter molecule, such predetermined length sufficient so as to allow detectable modulated movement under the application of an external field, the recognition molecules capable of binding with the target biomolecule, applying a modulating field selected from the group consisting of electrical fields, magnetic fields and acoustic fields, and detecting a fluorescent signal response based upon modulation of fluorescence the fluorescent signal arising from binding between the recognition molecules and the targeted species.

### BRIEF DESCRIPTION OF THE DRAWINGS

FIG. 1 shows a graphical view of the modulation approach in accordance with the present invention with light intensity is plotted versus distance from the substrate. The fall off of intensity of the evanescent field in moving away from the surface of the substrate is shown.

FIG. 2 shows a schematic view of exponential decay of emission intensity of a dye as it moves away from the surface of an optical waveguide surface.

FIG. 3 shows a graph depicting modulation of fluorescence emission of an unbound recognition molecule.

FIG. 4 shows a graph depicting modulation of fluorescence emission of a recognition molecule following binding to a target molecule.

FIG. 5 shows a general schematic view for films necessary for optical modulation of a binding event at the surface of an optical waveguide with the sub-structure on the left shown as fully extended while the sub-structure on the right has undergone electrical field modulation changes from fully extended to a compressed configuration.

FIG. 6 shows a schematic view of a single substrate surface containing recognition molecules for various targeted species such as, e.g., DNA for Bacillus anthracis, an antibody for Y. Pestis, GM1 for cholera and a peptide for a Hantavirus.

FIG. 7 shows a graphical view of a frequency sweep across which a multiplicity of targeted species (such as in FIG. 6) can be detected at a single substrate surface.

FIG. 8 shows a schematic view of a lipid bilayer film with a trifunctional linker adapted for optimization of the movement of a recognition molecule and associated dye in optical modulation.

FIG. 9 shows a self-assembled monolayer film based on hydrophilic polyethylene glycol units with a long PEG spacer linked to a reporter dye and a receptor or recognition molecule.

FIG. 10 shows a schematic view with the use of multidentate peptide or carbohydrate ligands in biosensors in accordance with the present invention.

FIG. 11 shows a schematic view of gene detection using bio-modulation technique of the present invention. Binding of a single stranded DNA attached to the surface with a complementary strand can result in the formation of rigid double-stranded DNA.

FIGS. 12(a) and 12(b) show a representative output from a frequency sweep of a single strand DNA (12a) and the single strand DNA following hybridization (12b).

### DETAILED DESCRIPTION

The present invention is concerned with both materials and processes that take advantage of an optical transduction technique utilizing modulation of a biological recognition event at the surface of a waveguide. This approach relies on fluorescence of a reporter material, such as a dye, that is attached to a recognition molecule whose position relative to the surface of a waveguide, e.g., a planar optical waveguide, is modulated by electric, magnetic or acoustic fields or a combination of such fields. This modulation in relative distance from the surface of the waveguide modulates the fluorescence emission by virtue of rapid changes in the evanescent field intensity as the distance from the surface increases. This sensor approach can allow simultaneously detection of multiple different marker molecules or organisms (generally up to as many as about 10 or more) using a single waveguide element. For example, both gene and protein markers as well as intact organisms may be detected on a single platform, and the sensor can be made reagent free and robust, i.e., environmentally stable. As the signal transduction relies on changes in the resonant modulation of the recognition or receptor molecule as it binds the target species whether an antigen, a gene or an intact organism, non-specific binding events that occur at the surface of the waveguide bound film or with the recognition or receptor molecule can be readily differentiated thereby eliminating background. As both the materials and processes can utilize generally any recognition or receptor molecule, including antibodies, it is a platform technology that can be widely applied to virtually any protein, gene marker molecule or organism. In one embodiment, by utilizing multiple recognition or receptor molecules that bind orthogonal epitopes of the same target species whether of a particular marker or organism, higher sensitivities can be achieved relative to conventional lab-based technique or conventional sensor technique by virtue of the surface avidity effect. In one embodiment, the binding to the particular targeted marker or organism may be reversible so as to regenerate the surface for reuse. Such reuse may become relevant where an intended application involves remote unattended applications.

The present invention further addresses the creation of the types of surface film and linkage to the labeled recognition molecule and the use of multidentate ligands with controlled charge to take full advantage of this modulation approach as well as adaptation of this modulation approach to the detection of other target species such as genes.

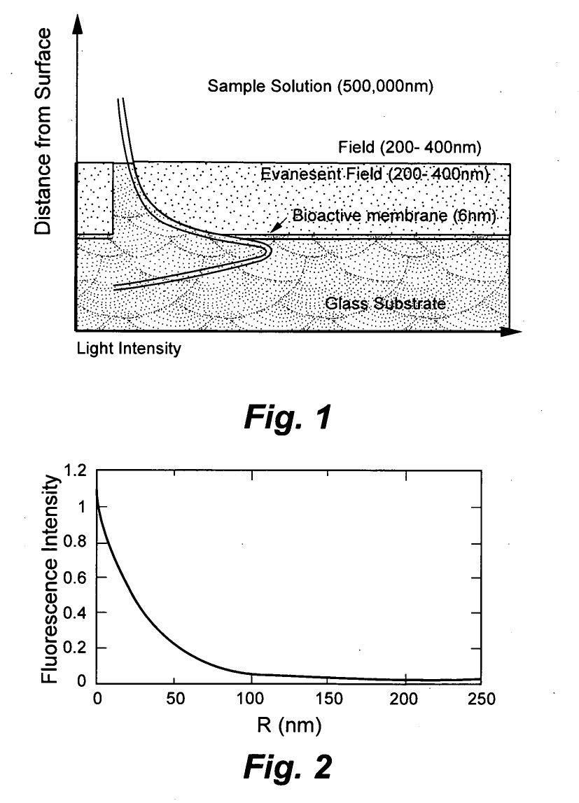

The present invention utilizes the rapid change in the intensity of the evanescent optical field as distance away from the surface of a single mode waveguide increases. The approach is shown in FIG. 1 and FIG. 2, which show the field intensity in the waveguide and fall-off of intensity of the evanescent field in moving away from the surface. The typical waveguide thickness for a single mode waveguide with a high index of refraction is about 120 nm while the typical thickness of the bioactive film at the surface is from about 3 to about 6 nm. The intensity of the evanescent field drops off exponentially and is essentially zero at roughly one-half the wavelength of the light used in excitation. For an example where an excitation laser light is at around 500 nm, the evanescent field would not penetrate beyond 250 nm.

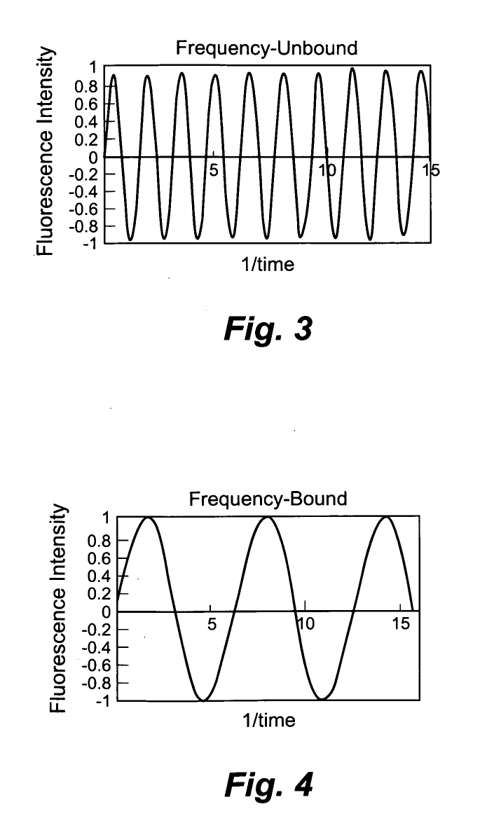

As the dye labeled recognition or receptor molecules (whether, e.g., an antibody, a peptide, a carbohydrate, a multidentate ligand, an aptamer, or a nucleotide) move away from the surface, the emission from the dye will decrease as the field intensity decreases. The converse is true as well, i.e., when a dye labeled receptor moves from a most distant point away from the surface to a position closer to the surface, the emission intensity will increase. The modulation of the emission intensity as a function of modulation of the position of the recognition molecule relative to the surface is shown in FIG. 3. The maximum change in the modulation of the emission intensity will occur if the recognition molecule moves the complete extent of a range in distance from the surface (dictated by the linker molecule) to as close as possible to the waveguide surface (dictated by the surface film above the waveguide).

The rate of change in the position of the recognition molecule relative to the surface will be determined by the field intensity used to modulate the position (electric field, for example), the mass and change of the recognition molecule and the viscous drag of the media through which it moves. For any given modulation field intensity, viscous drag and mass and charge of the recognition molecule, there will be a resonant frequency for the modulation of the recognition molecules position and, therefore, the emission intensity. The Q of this resonance (i.e., a quality factor of how sharp the resonant frequency is) can depend largely on variations in the mass of the recognition molecule. Most recognition molecules will have a well-defined mass and, therefore, a high Q for the resonant frequency (the width of the resonant frequency will be sharp). But the Q response, range and pattern of the output will generally be specific and well defined and distinctive for each recognition element—target species combination. Pattern recognition techniques may be employed to detect the change in pattern between the unbound state and the bound state.

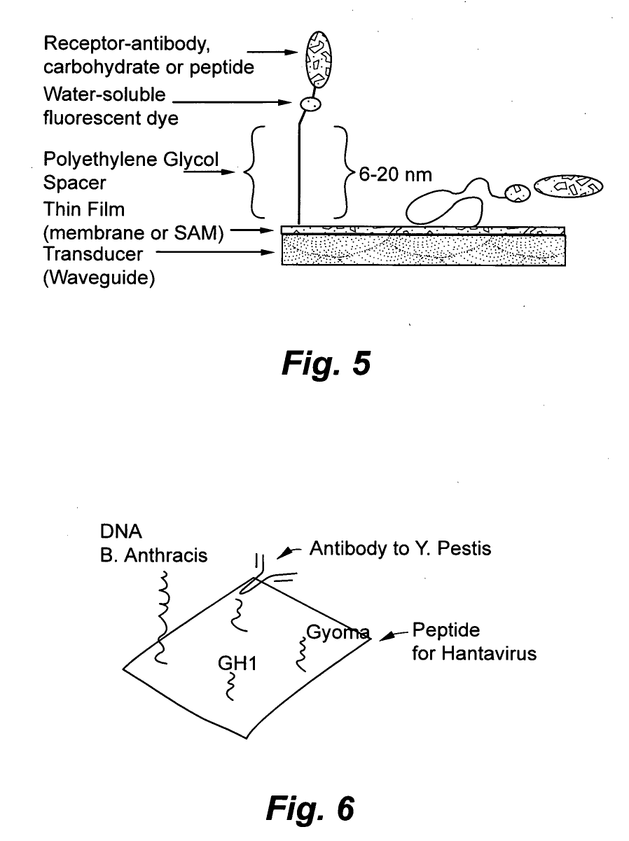

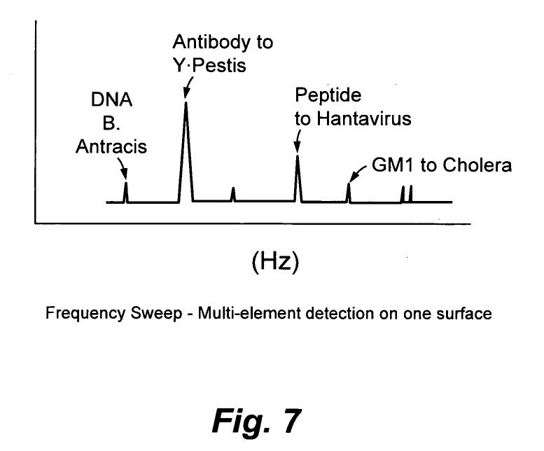

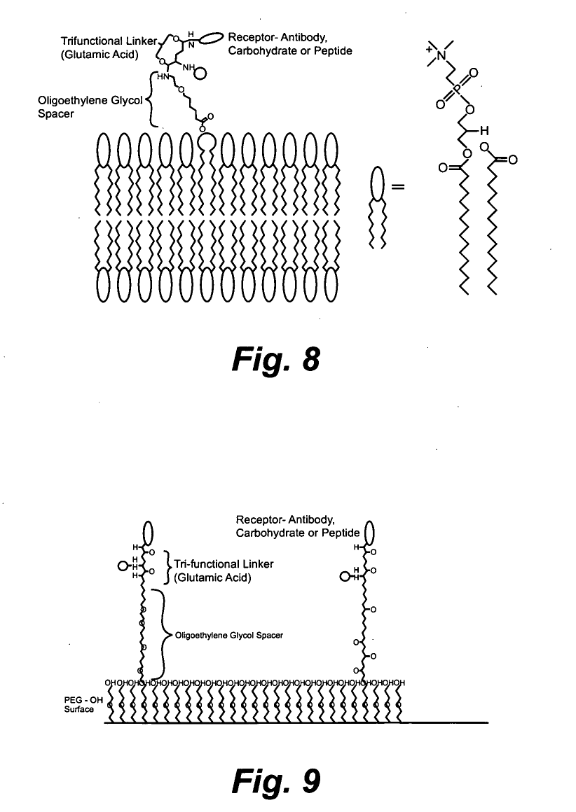

Binding of the targeted species, e.g., a marker molecule (usually a protein, intact organism or gene marker, although it could be some other marker molecule) will change the mass and possibly the charge of the capture-target molecule relative to the recognition molecule alone and, therefore, greatly alter the resonant frequency of the modulation. In effect, the resonance may be “de-tuned” and this change can be easy to pick up using lock-in detection techniques. The resonant frequency of the antigen-recognition molecule or gene-nucleotide pair after binding is much longer in frequency as the mass has greatly increased. In effect, if the detection is locked into the modulation of the original recognition molecule mass, this signal will decrease as the target binds and fewer dye-labeled recognition molecules move at the original resonant frequency. A schematic of the type of film chemistry and linker to the dye and the receptor molecule needed to effect this modulation is shown in FIG. 5. As the dominant change in emission intensity and optical field strength of the evanescent field will occur within the first 50 nm of distance away from the surface, the ideal surface would be a bio-active film that is a few nm thick with conjugation to a recognition molecule with a linker that permits movement of, e.g., from about 10 nm to about 30 nm. Moreover, the recognition film surface should be as uniform as possible and, moreover, not have large non-specifically bound molecules to impede the movement of the dye-labeled recognition molecule.

Detection of the modulation of the binding event can be dependent upon the property of the material that is modulated. For example, optical detection can be used for fluorescent dyes that are modulated. Squid detectors may be used to follow modulation of magnetic materials. The detection could also be of a change in a property such as capacitance. Detection in the present invention may involve use of a combination of detection such as, e.g., optical detection for fluorescence and magnetic detection for magnetic materials, and the like.

Given the above desirable attributes, the most ideal surface film is one that a) easily permits conjugation of a variable length linker that is coupled to the dye-labeled recognition molecule and b) has the property of minimizing non-specific adsorption of proteins and other molecules. Two surface films are detailed but others may be used as well. The first surface film is a phospholipid bilayer membrane that mimics cell membranes in nature. Nature has evolved similar lipid bilayers, which have excellent properties including the minimization of non-specific binding. In this case, the variable length linker attached to both the membrane and to the recognition molecule could be a trifunctional membrane-anchoring molecule such as described in U.S. patent application Ser. No. 10/104,158, filed on Mar. 21, 2002, for “Generic Membrane Anchoring System”. In that patent application the trifunctional amino acid (e.g., glutamic acid) was positioned at the surface of the membrane so that the dye could either be in the lipid phase or the aqueous phase near the membrane surface. In the present application, it is desired to turn the trifunctional amino acid portion around so that the dye can be positioned at the conjugation site that links the recognition molecule and the trifunctional linker. In this way, the dye can be made to move between the extremes of near the surface of the waveguide to the furthest extent dictated by the linker. In this case, a variable length linker made up of hydrophilic molecules such as polyethylene glycol (PEG) would be ideal. The length of this linker could be varied from a few PEG units up to 20-50 with uniformity of the number and the ultimate length of the linker. This type of membrane structure complete with linker is depicted in FIG. 6.

A second exemplary surface film is a PEG-ylated self-assembled monolayer (SAM) with uniform length PEG SAMs diluted with a small amount of a linker molecule based on PEG. This type of film is shown in FIG. 9. The total length of the linker can be adjusted incrementally by adding additional polymer chains of uniform length to get virtually any length one desires to optimize the modulation strength. One advantage to using PEG-ylated SAMs is that non-specific binding of proteins to the surface of the SAM can be minimized by washing with amphiphiles such as Tween™ surfactant, which will rinse off non-specifically bound proteins. This cannot be done with the first types of films (membranes), as they are not stable to washing with Tween™ surfactant. The minimization of non-specific binding is important largely because bound proteins may impede the movement of the dye labeled recognition molecules.

In addition to the trifunctional membrane-anchoring molecule described above as one suitable material for the linker, DNA could also be employed as the linker as it is a highly charged material. Also, more rigid linkers, e.g., linkers having repeatable tethers, such as coiled-coil peptides, double stranded DNA (dsDNA), and locked or Tinkered DNA (LDNA) could be used and may provide sharper resonances. Peptide nucleic acids (PNA) could be used in applications such as gene detection as PNA can recognize double stranded DNA.

The present invention does not generally employ antibodies, as they are not considered non-ideal for two reasons. First, antibodies have a charge distribution that is hard to control. The ability to modulate the distance of the recognition molecule from the surface is directly related to the charge and mass of the recognition molecule and clearly antibodies may not work for certain sample matrices. Further, antibodies are not generally stable to heat and other environmental influences. In a few instances of the present invention, antibodies may be employed for a particular target species but in combination with other recognition molecules for either the same target or other targets.

More stable or robust recognition molecules are needed and it is intended to use environmentally stable ligands that are not degraded by heat, moisture or simply passage longer periods of time. Such stable ligands may be, e.g., ligands such as multidentate carbohydrates or small peptides. In these cases, the charge on the ligand to optimize the extent of modulation relative to the substrate surface can be easily controlled. Peptides would be obtained using a peptide phage display, which can be used to select, from a large peptide library, those peptides that bind well to either marker proteins or to intact organisms. The attractiveness of using peptides is that the peptide phage display selection process is well established and permits easy selection of the best binders from large libraries. The charge on the peptide can be controlled by appending a string of amino acids with known charge to either end of the peptide. Another type of suitable recognition molecule, i.e., multidentate carbohydrates, is attractive because nature uses such carbohydrates in many cell-signaling processes. One disadvantage of carbohydrates is that although large libraries can be prepared, the selection process used to finding the best binding carbohydrates for a given target species can be challenging.

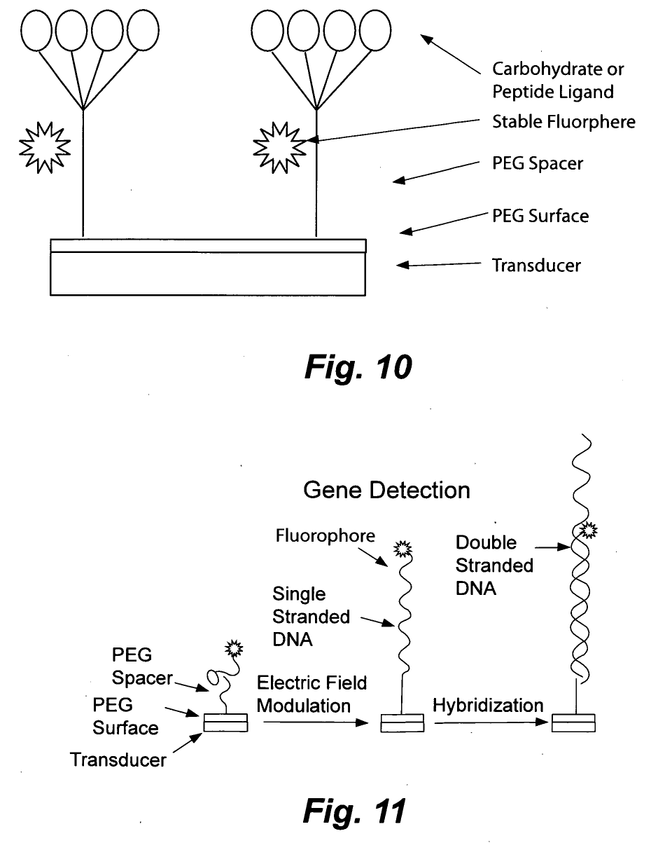

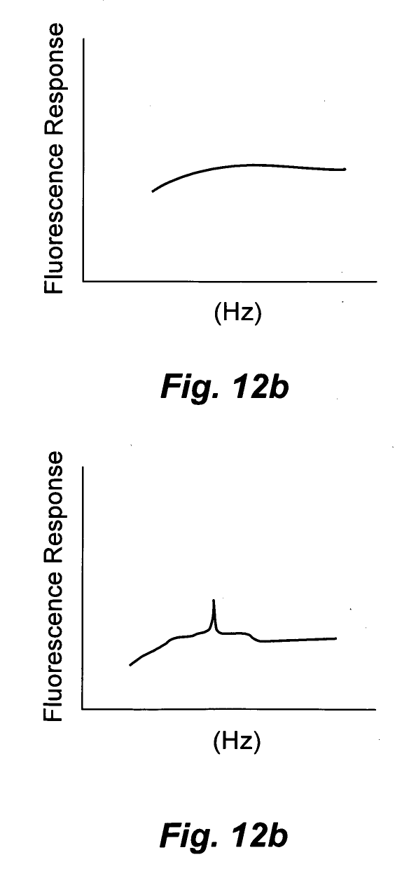

The reason that peptides and carbohydrates have not yet found favor as recognition molecules in sensing is that their single site binding affinities and their specificities are low relative to antibodies. Yet, this can be overcome for many target proteins and for all intact organisms by utilizing multidentate recognition molecules where up to four peptides or carbohydrates (the same of different) can be coupled into a single flexible molecules that can be attached to the space molecule described above. A schematic of a suitable multidentate recognition molecule is depicted in FIG. 10. The use of a multidentate recognition molecule enhances both binding affinities and specificities. By way of example, the single site binding affinities for the glycolipids GM1 to cholera is 10⁷. However, cholera can bind up to five of these carbohydrate recognition molecules and it has been previously demonstrated that using membrane-based FRET detection system sensitivity is increased by five orders of magnitude over a single GM1 binding event (see Song et al., J. Am. Chem. Soc., v. 120, no. 44, pp. 11514-11515 (1998)). The advantage of using peptide or carbohydrate based multidentate recognition molecules is that charge can be controlled, thereby optimizing modulation, and that they are stable molecules and, when combined with PEG-ylated SAMs (above) form stable, robust sensing films. The control of charge is also easily available in gene detection, as described below.

The two above surface films and approaches to linker chemistry that can be used to modulate the recognition event between the recognition molecule and the target protein or gene marker also lend themselves to multiplexing where more than one target can be detected and quantified on the same sensor pad. In one embodiment, this requires that more than one recognition molecule with it's own reporter molecule, e.g., a fluorescent dye, be conjugated to the surface and the above chemistries permit this to be done. Each recognition molecule must have a reporter molecule, e.g., fluorescent dye molecule, with a distinct emission spectrum so that each can be modulated independently. Each recognition molecule that targets different marker proteins or genes could be encoded using different length spacers, different charges on the molecule, different masses and the like, so that the modulation resonance is distinct and yields different shaped spectra as an output.

Although a focus of this work has been on the detection of proteins, it is believed that the present sensor can be used in other applications and can also be used for the direct detection (i.e., without PCR amplification) of genes. Single- or double-stranded DNA could be conjugated to a spacer that, in turn is conjugated to the surface of the SAM or membrane film. The nucleotide can be modified so that a dye molecule is appended to the terminus that is furthest removed from the surface when the single- or double-stranded DNA and the spacer are at their most extended conformation. Gene fragments have a large negative charge and it should be possible to modulate their distance from the surface easily using electric field modulation. Upon hybridization with a target, complimentary DNA fragment, a portion of the two strands would form a rigid rod structure that would change the modulation, and possibly, damp out any modulation of florescence emission by the electric field. A schematic of the process is shown in FIG. 11.

Results have been previously published (see Duveneck et al., Analytical Chemistry, v. 469, pp. 49-61 (2002)) that demonstrate that DNA genes can be detected without any amplification using single mode waveguides of the type utilized in the present invention. That prior sensor system was based on a small array where each element has an individual grating structure to couple in light. That system also relied on a sandwich assay approach where a second reporter DNA fragment was added after binding of the target gene. In the present approach, the assay is reagent-less and would not require the addition of a second reporter DNA fragment. In any event, in the present invention, target genes may be detected without first amplifying using PCR. As described above, the specific capture DNA fragments could be encoded using different length spacers, as they would have distinct resonant frequencies for modulation. In this way, multiple target genes could be detected using a single element. This multiplex advantage may play out in arrays where one is probing a large number of different genes.

Although the present description has primarily described electric field modulation of the recognition molecule relative to the transducer surface, other modulation approaches could be used as well. These include, e.g., acoustic modulation and magnetic field modulation. In the case of magnetic field modulation it would be necessary to attach magnetic particles to the terminus of the linker near the point where the linker is attached to the recognition molecule. It is possible that use of different size magnetic particles could allow encoding of different recognition molecules for the simultaneous detection of multiple targets on a single element in an array for high-throughput analysis.

The present invention could have wide applications for many different types of sensor needs using different transducers. The key differences between one current waveguide-based sandwich assay (see U.S. Provisional Patent Application Ser. No. 60/583,911, filed on Jun. 29, 2004) and the present invention include: 1) the ability to avoid any reagents; 2) the elimination of background signals due to non-specific binding; 3) the ability to multiplex; and, 4) the ability to detect both genes and proteins (as well as intact organisms) on a single sensor platform. A general consensus has been formed amongst the sensor user community that the most desirable attribute for next generation sensing is for them to be reagent-less. The improvements achievable with the present approach (e.g., reagent-less, elimination of background, simultaneous protein and gene detection, and multiplexing) are hugely important for many applications, such as autonomous, real-time sensing in the field as well as high-throughput analysis where the desire is to probe many different proteins and genes. They are also important for medical diagnostics where an inexpensive sensor cartridge capable of detecting and quantifying multiple target markers simultaneously is often important. One example is applications for the early diagnosis and monitoring of common infections (e.g., tuberculosis) in a third world county. The present invention provides for control over modulation and detection through both input and output modes therefore yielding flexibility in signal transduction.

The base substrate in the present invention is a waveguide and more preferably a single mode planar optical waveguide. The waveguide is generally of a high index material. Use of a waveguide can eliminate some problems related to background autofluorescence from complex samples and Raman scattering from water. Preferably, the waveguide surfaces will be of a material that can be employed to attach an intervening thin film material, such materials including, e.g., silica, silicon nitride, titania, mixtures of silica and silicon nitride often referred to as SiON, and the like. The materials used for the waveguide can be a sol-gel material.

The present invention involves the use of recognition molecules bound to a film on the base substrate or waveguide. By “recognition molecule” is meant a molecule or ligand capable of recognizing and having a binding affinity for a specific target such as a biomolecule. Among such molecules or ligands capable of recognizing and having a binding affinity for a specific target are included peptoids, single chain Fv molecules (scFv), peptides and mimetics thereof, carbohydrates, sugars and mimetics thereof, oligosaccharides, proteins, nucleotides and analogs thereof, aptamers, affinity proteins, small molecule ligands and receptor groups. Other suitable recognition molecules can include biomolecules such as antibodies, antibody fragments, i.e., a portion of a full-length antibody such as, e.g., Fab, Fab′, F(ab′)₂, or Fv fragments and the like, recombinant or genetically engineered antibody fragments, e.g., diabodies, minibodies and the like.

The recognition molecules can be linked or bound through various molecules to the film on the waveguide surface. Among suitable linking molecules can be various biotin-avidin linkages such as biotinylated lipids, and trifunctional linker molecules as described by Schmidt et al., U.S. Ser. No. 10/104,158, “Generic Membrane Anchoring System”, filed on Mar. 21, 2002, such description incorporated herein by reference. Such trifunctional linker molecules can include membrane-anchoring groups where the film is a membrane. Such trifunctional linker molecules can be used where a reference dye is incorporated into the system by addition onto one arm of the trifunctional linker molecules. Such trifunctional linkers may also include a secondary recognition ligand in addition to the primary recognition molecule. The use of a secondary recognition molecule that binds an orthogonal epitope relative to the primary recognition molecule can serve to enhance the effective binding affinity thereby increasing the overall sensitivity of the sensor.

The base substrate includes a film thereon, the film being a bilayer membrane, a hybrid bilayer membrane, a polymerized bilayer membrane, or a self assembled monolayer (SAM) containing polyethylene glycol or polypropylene glycol groups therein. The term “polymerized membrane” refers to membranes that have undergone partial or complete polymerization. One example of a polymerized membrane can be polymerized phospholipids prepared from polymerizable monomer groups as shown, e.g., in U.S. Pat. No. 6,699,952.

By “membrane” is generally meant supported bilayers where membrane layers are deposited upon a support surface, hybrid bilayers where a first layer is covalently attached to an oxide surface, tethered bilayers where a membrane molecule is covalently bonded to the oxide substrate, or bilayers cushioned by a polymer film. Supported membranes useful in the practice of the present invention are generally described by Sackmann, in “Supported Membranes: Scientific and Practical Applications”, Science, vol. 271, no. 5245, pp. 43-45, Jan. 5, 1996.

Formation of a bilayer membrane upon the waveguide surface can be accomplished by vesicle fusion, a process well known to those skilled in the art. Formation of either supported bilayer or hybrid bilayer membranes can also be accomplished using Langmuir-Blodgett techniques.

A self-assembled monolayer can be attached to the substrate as follows: solution self-assembly using siloxane groups such as octadecyltrichlorosilane (OTS) or by Langmuir-Blodgett assembly using a LB trough.

The lipid components that can be used for the membrane layers in the present invention are generally described in the literature. Generally, these are phospholipids, such as, for example, phosphatidylcholines, phosphatidylethanolamines, phosphatidylglycerols, phosphatidylserines, phosphatidic acids, phosphatidylinositols or sphingolipids.

In one embodiment of the present invention, dye-labeled reporter materials can be attached to the recognition molecules, e.g., through a trifunctional linker molecule, to provide for an output signal. Suitable dyes for the reporter materials can include fluorophores such as, but not limited to, fluorescein, cadaverine, Texas Red™ (Molecular Probes, Eugene, Oreg.) and Cyanine 5™ (BDS, Pennsylvania). Generally, any fluorophore will typically be detectable in the visible to near infrared range, although other ranges may be used as well. Quantum dots, metal clusters, porous silica and other nanoshell materials may also be used as reporter dyes or magnetic materials.

In one aspect of the present invention, the entire setup could be turned around such that a particular target molecule of interest is attached through a suitable linker onto a sensor platform and a series of ligands evaluated for potential binding to that target. In this manner, suitable ligands for later sensing applications could be found through screening of a library of materials such as carbohydrate pieces, peptide pieces and the like. For example, a series of materials could be flowed individually past a target, e.g., a virus or part of a bacteria, and a demodulation out of phase (disappearance of all or part of the signal) could be sought for indication of binding with a particular small ligand or molecule to a biological target. This approach may have applications in screening of combinatorial libraries of potential drug candidates and combinations of drug candidates.

Although the present invention has been described with reference to specific details, it is not intended that such details should be regarded as limitations upon the scope of the invention, except as and to the extent that they are included in the accompanying claims.

1. An optical waveguide sensor for the detection of a binding event to a target molecule comprising:
an optical waveguide;
a fluid membrane or self assembled surface thereon said optical waveguide;
recognition molecules situated near said fluid membrane or self assembled surface by: (a) in the case of a fluid membrane, a trifunctional linker molecule including a recognition molecule, a fluorescent reporter molecule, anchoring groups for situating within said fluid membrane and a spacer group of a predetermined length between the anchoring groups and the portion of the trifunctional linker structure containing the recognition molecule and the fluorescent reporter molecule or (b) in the case of a self assembled surface, a trifunctional linker molecule including a recognition molecule, a fluorescent reporter molecule, and a spacer of a predetermined length capable of binding at said self assembled surface, where said spacer is positioned between the self assembled surface and the portion of the trifunctional linker structure containing the recognition molecule and the fluorescent reporter molecule, such predetermined length sufficient so as to allow detectable modulated movement under the application of an external field, said recognition molecules capable of binding with said target molecule;
an optical energy source for generating both an evanescent field at the surface of said optical waveguide and exciting the fluorescent reporter molecule so as to generate detectable fluorescence signals;
an electrical field modulation source capable of causing changes in positional location of said recognition molecules relative to said optical waveguide; and,
a detector positioned so as to allow for sensing of the fluorescence signals from the waveguide.

2. The sensor of claim 1 wherein said spacer group is an oligoethylene glycol.

3. The sensor of claim 1 wherein said target molecule is a biomolecule other than an antibody.

4. The sensor of claim 1 wherein said sensor further includes a detector for a secondary surface proximity modulation signal.

5. (canceled)

6. (canceled)

7. (canceled)

8. A method of detecting a targeted species comprising:
contacting a sample with an optical waveguide sensor having a fluid membrane or self assembled surface thereon said optical waveguide, a chemical moiety including recognition molecules situated near said fluid membrane or self assembled surface by: (a) in the case of a fluid membrane, a trifunctional linker molecule including a recognition molecule, a fluorescent reporter molecule, anchoring groups for situating within said fluid membrane and a spacer of a predetermined length between the anchoring groups and the portion of the trifunctional linker structure containing the recognition molecule and the fluorescent reporter molecule or (b) in the case of a self assembled surface, a trifunctional linker molecule including a recognition molecule, a fluorescent reporter molecule, and a spacer of a predetermined length capable of binding at said self assembled surface, where said spacer is positioned between the self assembled surface and the portion of the trifunctional linker structure containing the recognition molecule and the fluorescent reporter molecule, such predetermined length sufficient so as to allow detectable modulated movement under the application of an external field, said recognition molecules capable of binding with said target biomolecule;
applying a modulating field selected from the group consisting of electrical fields, magnetic fields and acoustic fields; and
detecting a fluorescent signal response based upon modulation of fluorescence said fluorescent signal arising from binding between said recognition molecules and said targeted species.

9. The method of claim 8 wherein said target molecule is a biomolecule.

10. The method of claim 8 wherein said detecting further includes detection of a secondary surface proximity modulation signal said detection from the group of magnetic detection, electronic detection and spectroscopic detection.

11. The method of claim 8 wherein said spacer group is an oligoethylene glycol.
